(19) United States
(12) Patent Application Publication
(10) Pub. No.: US 2003/0107714 A1
(43) Pub. Date: Jun. 12, 2003

(54) Method and system for improving asymmetrical projection

(76) Inventor: Chu-Ming Cheng, Hsinchu (TW)

Correspondence Address: NAIPO (NORTH AMERICA INTERNATIONAL PATENT OFFICE), P.O. BOX 506, MERRIFIELD, VA, 22116, US

(21) Appl. No.: 10/309,817

(22) Filed: Dec. 5, 2002

(30) Foreign Application Priority Data
Dec. 7, 2001 (TW) 090130709

(51) Int. Cl. G03B 21/00

(52) U.S. Cl. 353/69

(57) ABSTRACT

A method for improving a symmetrical projection is provided. The projection system includes a light source, a light valve, and an integration rod. The method utilizes the light source to emit light beams that travel through the integration rod and obliquely project onto the light valve, and adjusting a cross section of the integration rod to offset image distortion existing in the projection system.

### BACKGROUND OF THE INVENTION

1. Field of the Invention

The present invention relates to a projection method and, more particularly, to a projection method and systems for improving asymmetrical projection.

2. Description of the Prior Art

In recent years, data visualization has become an important issue in the information industry. The demand and importance for a projection display device capable of displaying data have rapidly increased. Therefore, manufacturers make an effort to provide a projection display device that produces high image quality.

Please refer to FIG. 1, which is a schematic diagram of an optic projection system 20 according to the prior art. The optic projection system 20 is a single panel digital micro-mirror device (DMD) projection system. A light source 21 comprises a parabolic reflector 211. Light beams 22, generated by the light source 21 and reflected by the parabolic reflector 211, pass through a converging lens 23 and then converge into a color wheel 24 that is formed by a series of red, green and blue filters for transforming the white light beams 22 into colored light beams 221. After the light beams 22 pass through the color wheel 24 and are transformed into the colored light beams 221, the colored light beams 221 enter an integration rod 25 to uniform the brightness of the colored light beams 221, and then sequentially pass through a condenser lens 26, a stop 27, and a relay lens 28, and finally converge into a prism illumination system 30 which is capable of reflecting the colored light beams 221 with a reflection surface 31 onto a light valve 10, like a digital micro-mirror device (DMD).

The light valve 10 is formed with a plurality of pixel lens (not shown) which are disposed in a matrix and capable of pivotably rotating within a range of +12 to −12 degrees. When the light valve 10 is in an ON state, the pixel lenses reflect an incident light beam onto a screen. When the light valve 10 is in an OFF state, the pixel lenses reflect an incident light beam onto a region outside of the screen. When the light valve 10 is in a FLAT state, the pixel lenses are disposed parallel to the substrate of the light valve 10. The light valve 10 selectively reflects the colored light beams 221 through the prism illumination system 30 and further through a projection lens 32 and finally onto a screen 33.

Please refer to FIG. 2 and FIG. 3. If the converging lens 23, the color wheel 24, the integration rod 25, the condenser lens 26, the stop 27, and the relay lens 28 are all perfectly symmetrical and assembled, a cross section of rectangular-shaped light beams 41 projected from the relay lens 28 is similar to the cross section of the integration rod 25. As shown in FIG. 3, the length of a first diagonal line L1 equals the length of a second diagonal line L2. That is, no image-distortion occurs. When the normal rectangular-shaped light beams 41 continue to travel into the prism illumination system 30, the reflection surface 31 of the prism illumination system 30 reflects the rectangular-shaped light beams 41 onto the light valve 10 and forms a light spot 42 shown as dashed lines in FIG. 4. Referring to FIG. 4, which shows the light spot 42 obliquely projected from the reflection surface 31 onto the light valve 10 of the optic projection system 20 according to the prior art, because the light beams 41 are obliquely projected onto the light valve 10, the rectangular-shaped light beams 41 are inevitably distorted and transformed into the light spot 42, the first diagonal line L1 and the second diagonal line L2 of which being not equal (L1>L2). The distorted rectangular-shaped light beam 42 is indicated by dashed lines. Therefore, the light spot 42, failing to completely cover the light valve 10, disables the light valve 10 from completely reflecting the whole image onto the screen 33. To overcome this drawback, the method adopted by the optic projection system 20 in the prior art is to enlarge the light spot 42 into an enlarged light spot 43 to cover the whole light valve 10.

Please refer to FIG. 5, which shows the enlarged light spot 43 projected on the light valve 10 of the optic projection system 20 according to the prior art. In contrast to the light spot 42, although the light spot 43 indeed covers the whole light valve 10, part of the light spot 43, a light spot 431 shown as a hashed area in FIG. 5, still cannot be reflected onto the screen 33 by the light valve 10, resulting in luminance loss of the optic projection system 20.

In summary, the optic projection system in the prior art has at least two drawbacks:

1. Poor light uniformity due to the distortion of the light beams 42; and

2. Low illumination efficiency due to the luminance loss resulting from the prolonged first diagonal line L1.

### SUMMARY OF THE INVENTION

One objective of the invention is to provide an integration rod to offset the distortion and to transform the asymmetrical light spot to a symmetrical light spot to increase the illumination efficiency and uniformity of the projection system.

Other objective of the invention is to provide an integration rod to extend colored light beams to directions along a certain axis to form an oval-shaped light spot to overcome the drawback of the overlapping between the ON-state light beams and the FLAT-state light beams and to increase the contrast and the illumination efficiency.

According to the invention, the projection system includes a light source, a light valve, and an integration rod. The method includes utilizing the light source to emit light beams that travel through the integration rod and obliquely project onto the light valve, and adjusting a cross section of the integration rod to offset image distortion existing in the projection system.

It is an advantage of the invention that a projection system having a distorted cross-sectioned integration rod can transform an asymmetrical light spot to a symmetrical light spot.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

37 CFR 1.84 (b) (2)

The patent or application file contains at least one drawing executed in color. Copies of this patent or patent application publication with color drawing(s)will be provided by the Office upon request and payment of the necessary fee.

FIG. 1 is a schematic diagram of an optic projection system according to the prior art.

FIG. 2 shows a diagram of a cross section of the integration rod of the optic projection system shown in FIG. 1.

FIG. 3 shows a diagram of a cross section of rectangular-shaped light beams projected from the relay lens.

FIG. 4 shows a light spot obliquely projected from the reflection surface and onto the light valve of the optic projection system shown in FIG. 1.

FIG. 5 shows an enlarged light spot projected on the light valve of the optic projection system shown in FIG. 1.

FIG. 6 is a projection system according to the present invention.

FIG. 7 shows a cross section of the integration rod of the projection display system shown in FIG. 6.

FIG. 8A is a diagram of light distribution of the colored light beams projected onto the light valve of the optic projection system shown in FIG. 1.

FIG. 8B is a diagram of light distribution of the colored light beams projected onto the light valve of the projection system shown in FIG. 6.

FIG. 9A is a screen diagram of the optic projection system shown in FIG. 1.

FIG. 9B is a screen diagram of the projection system shown in FIG. 6.

FIG. 10A shows a light spot of colored light beams on the diaphragm according to the prior art.

FIG. 10B shows a light spot of colored light beams on the diaphragm according to the present invention.

FIG. 11 shows the light spot of ON-state light beams, OFF-state light beams, and FLAT-state light beams on the diaphragm according to the prior art and the present invention.

FIG. 12 shows a table of experimental performance results of the projection systems respectively according to the prior art and the present invention.

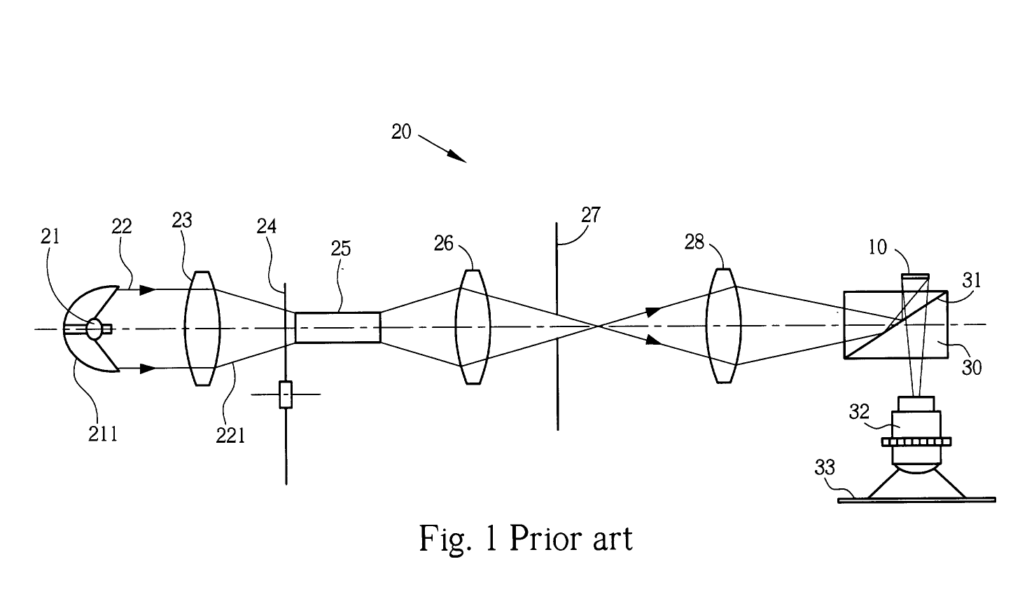

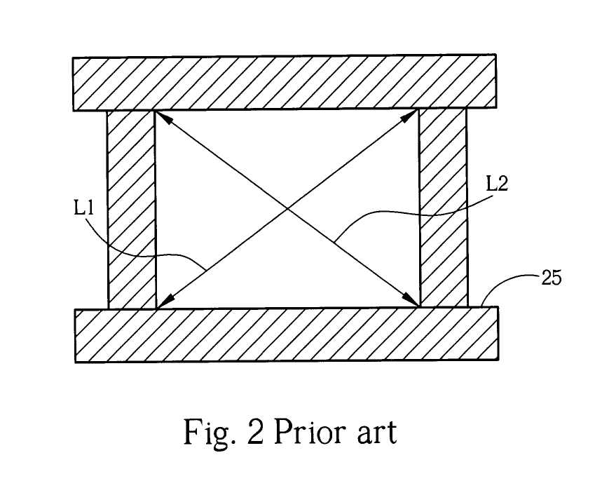

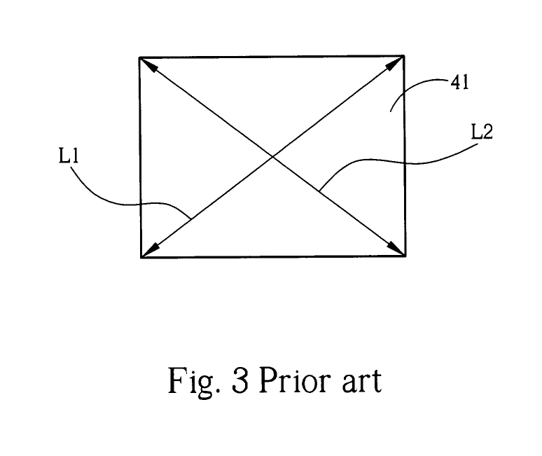

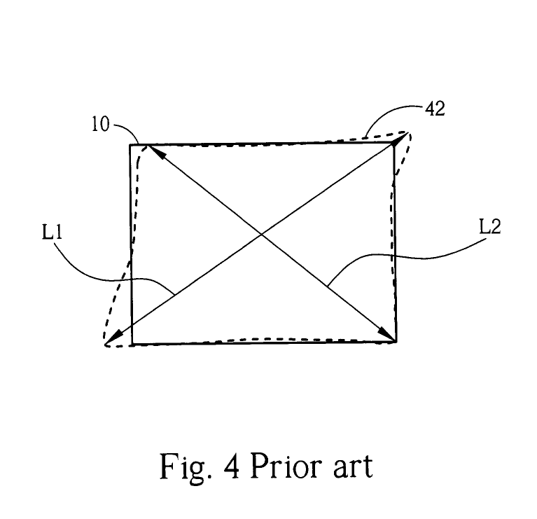

### DETAILED DESCRIPTION OF THE PREFERRED EMBODIMENT

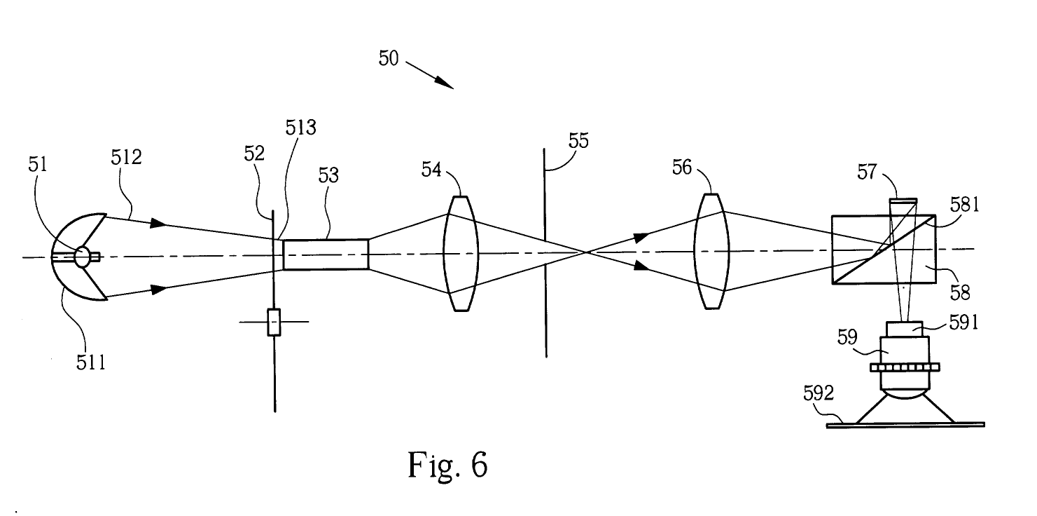

Please refer to FIG. 6, which is a preferred embodiment of a projection system 50 according to the present invention. A light source 51 comprises an elliptical reflector 511 to reflect light beams 512 generated by the light source 51 and to converge the light beams 512 into a color-generating device 52, such as a color wheel or a filter, that is formed by a series of red, green, and blue filters for sequentially filtering the light beams 512 and transforming the light beams 512 into colored light beams 513. The colored light beams 513 enter an integration rod 53 to uniform the brightness of the colored light beams 513 and then sequentially pass through a condenser lens 54, a stop 55, a relay lens 56, and finally converge onto a prism illumination system 58 capable of reflecting the colored light beams 513 with a reflection surface 581 onto a light valve 57, for example a digital micro-mirror device (DMD). The light valve 57 is formed with a plurality of pixel lens, which is disposed in a matrix and capable of pivotably rotating within a range of +12 to −12 degrees, and selectively reflects the colored light beams 513 by means of ON-state or OFF-state. After being reflected by the light valve 57 and passing through the prism illumination system 58, the colored light beams 513 enter a diaphragm 591 of a projection lens 59 and finally project onto a screen 592.

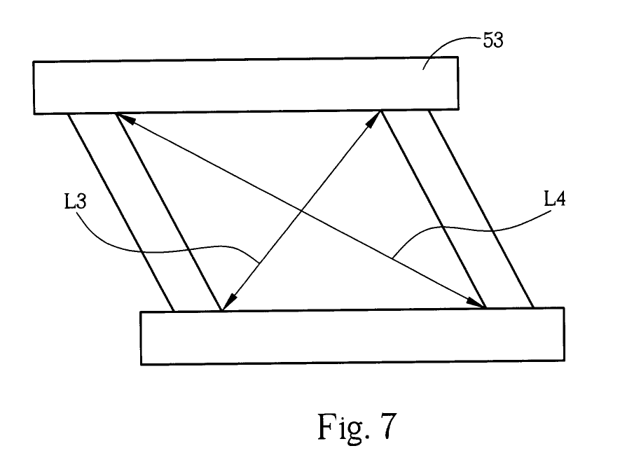

Please refer to FIG. 7, which shows a cross section of the integration rod 53 of the projection system 50 according to the present invention. The projection system 50 offsets the image distortion existing in the prior art optic projection system 20 with the integration rod 53, which has a distorted cross section, to improve the asymmetrical light spot 42 of the prior art into a symmetrical light spot. The shape of the cross section of the integration rod 53 is determined by the image distortion formed by the oblique projection of the colored light beams 513. That is, the integration rod 53, whose parallelogram-shaped cross section has two diagonal lines L3 and L4 respectively extending in two directions respectively opposite to the prolonged directions of the first diagonal line L1 and of the second diagonal line L2, deforms the colored light beams 513 before the colored light beams 513 reach the light valve 57 to generate the symmetrical light spot. In such away, the asymmetrical light spot 42 originated from the colored light beams 513 reflected by the reflection surface 581 and obliquely projecting onto the light valve 57 will be offset by the asymmetrical cross section of the integration rod 53 in advance and therefore form the symmetrical light spot.

Of course, a different cross section of the integration rod 53 can be applied to offset the distortion to any extent. The integration rod 53 can be hollow or solid. Additionally, certain sizes of colored light beams 513 can be integrated by the integration rod 53 having specific characteristics.

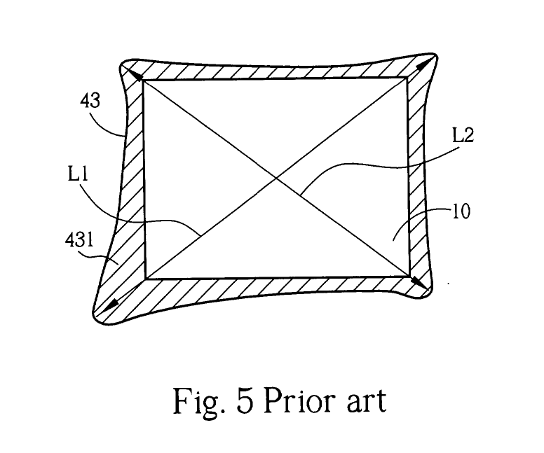

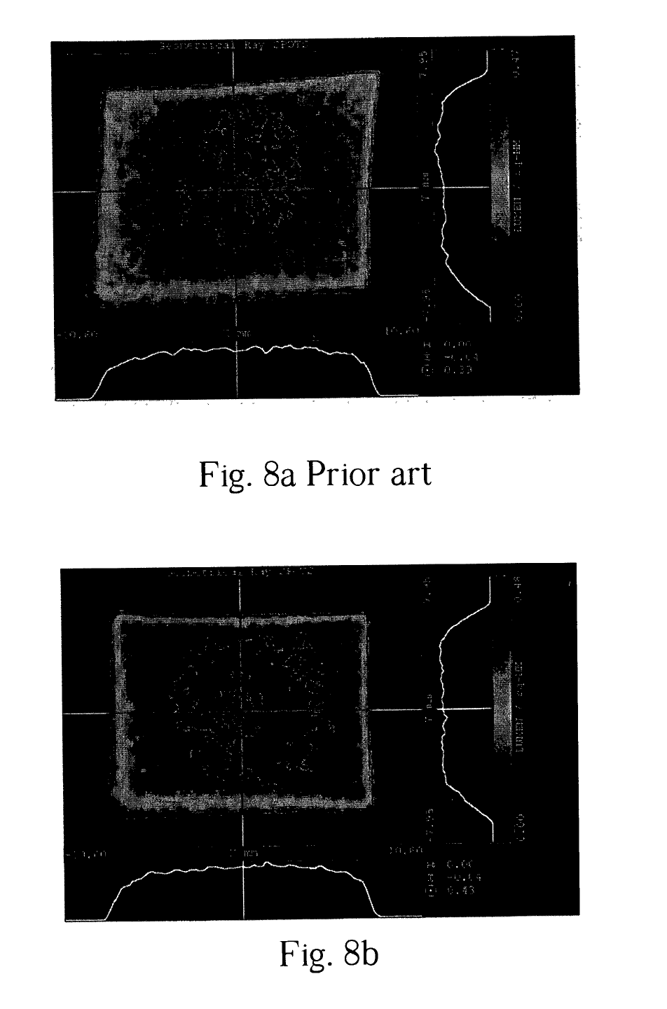

Please refer to FIG. 8A and FIG. 8B. FIG. 8A is a diagram of light distribution of the colored light beams 221 projected onto the light valve 10 of the optic projection system 20 according to the prior art. FIG. 8B is a diagram of light distribution of the colored light beams 513 projected onto the light valve 57 of the projection system 50 according to the present invention. As shown in FIG. 8A, a bottom-left corner and a top-right corner of the light distribution diagram are both prolonged (the first diagonal line L1 is longer than the second diagonal line L2, referring to FIG. 5) due to the obliquely projecting colored light beams 211 of the optic projection system 20. On the other hand, because the colored light beams 513 have been offset by the integration rod 53 having the distorted cross section before the colored light beams 513 projects onto the light valve 57, the light distribution diagram shown in FIG. 8B has been improved from the asymmetrical light spot 42 to a symmetrical rectangular-shaped light spot. It can be readily seen that the prolonged corners of the light distribution diagram shown in FIG. 8A have been improved.

Therefore, parts of the light spot out of the light valve 57 are smaller than that of the prior art, so the loss of the symmetrical light spot generated by the projection system 50 is less than that of the asymmetrical light spot 42 generated by the optic projection system 20 and the brightness of projected images of the projection system 50 is greater than that of the projected images of the prior art optic projection system 20.

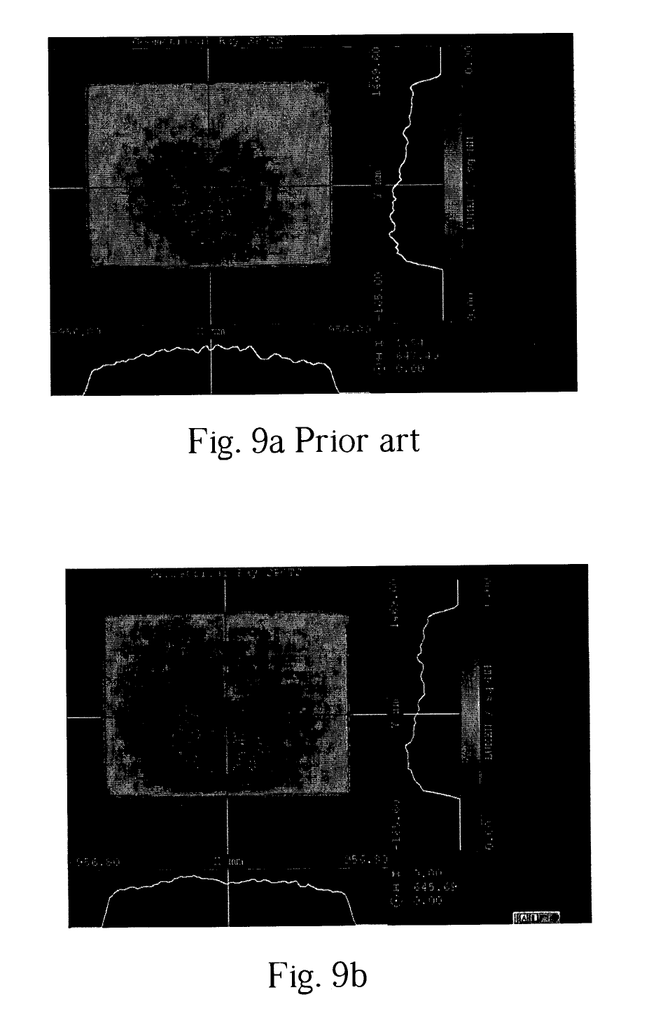

Please refer to FIG. 9A and FIG. 9B. FIG. 9A is a screen diagram of the optic projection system 20 according to the prior art. FIG. 9B is a screen diagram of the projection system 50 according to the present invention. In FIG. 9A and FIG. 9B, red dots represent high light intensity and green dots represent low light intensity. It can be seen that the high light intensity region occupied by the red dots in FIG. 9B is larger and more even than that in FIG. 9A. So, the projection system 50 according to the present invention is superior to the prior art optic projection system 20. An x-axis screen curve shown on the bottom side of FIG. 9B is flatter than an x-axis screen curve shown on the bottom side of FIG. 9A and a y-axis screen curve shown on the right side of FIG. 9B is flatter than a y-axis screen curve shown on the right side of FIG. 9A, further supporting the above conclusion.

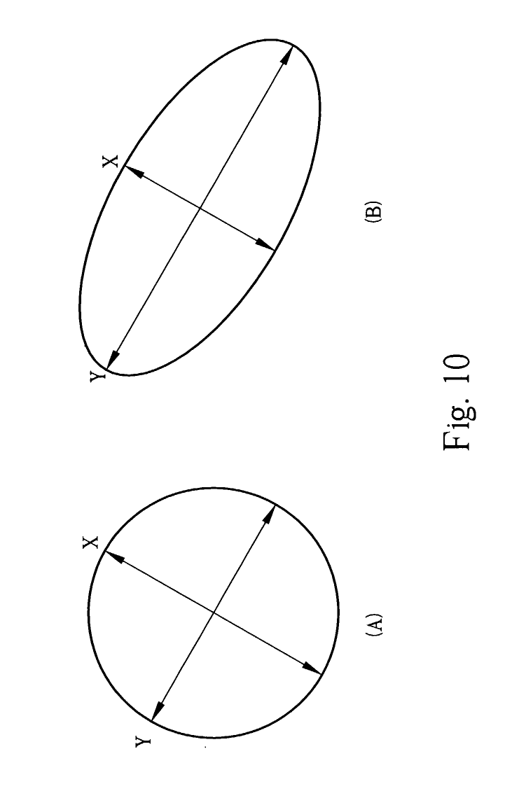

Please refer to FIG. 10A and FIG. 10B. FIG. 10A shows a light spot of colored light beams projected onto the diaphragm of the projection lens 32 when the integration rod 25 has a rectangular-shaped cross section (the lengths of two diagonal lines of a rectangular are equal) according to the prior art. FIG. 10B shows a light spot of colored light beams projected onto the diaphragm 591 of the projection lens 59 when the integration rod 53 has a parallelogram-shaped cross section (the lengths of two diagonal lines of a parallelogram are not equal) according to the present invention. The shape of the light spot shown in FIG. 10A due to the rectangular-shaped integration rod 25 is circular. However, the integration rod 53 having parallelogram-shaped cross section extends the light spot shown in FIG. 10A to directions along a certain axis, say a y-axis, transforming the circular light contrast diagram to an elliptical one.

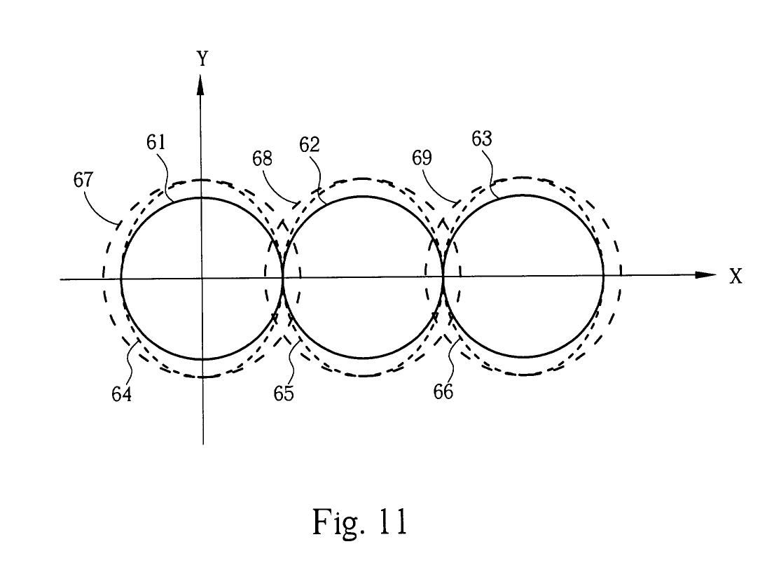

Please refer to FIG. 11, which shows the light spot of ON-state light beams, OFF-state light beams, and FLAT-state light beams on the diaphragm according to the prior art and to the present invention respectively. ON-state light beams 61, FLAT-state light beams 62, and OFF-state light beams 63 according to the prior art are respectively represented by solid lines, and ON-state light beams 64, FLAT-state light beams 65, and OFF-state light beams 66 according to the present invention are respectively represented by dashed lines. Theoretically, only the ON-state light beams will enter the diaphragm of the projection lens, so the larger the radius of the diaphragm of the projection lens and the larger the ON-state light beams 64, the higher brightness of projected images. However, when the ON-state light beams 61 continue getting larger and form another ON-state light beam 67, the OFF-state light beams 63 and the FLAT-state light beams 62 will accordingly get larger and then respectively form another FLAT-state light beams 68 and another OFF-state light beams 69. The FLAT-state light beams 68 overlap the ON-state light beams 67 and thus reduce the contrast of the projected images. Consequently, that the light beams 61, 62, and 63 are adjacent but not overlapping one another is a tradeoff between the brightness and the contrast of the projected images.

In contrast to the prior art optic projection system 20, the present invention can provide a projection system 50 for offsetting distortion in projected images with the integration rod 53 having the parallelogram-shaped cross section to transform the asymmetrical light spot 42 into a symmetrical light spot. Additionally, the ON, FLAT, and OFF-state light beams 61, 62 and 63 can be extended in directions along the y-axis and respectively form the ON, FLAT, and OFF-state light beams 64, 65, and 66, whose size are larger than that of the ON, FLAT, and OFF-state light beams 61, 62 and 63, to increase the intensity of light beams and to prevent the ON, FLAT, and OFF-state light beams 64, 65, and 66 from overlapping one another.

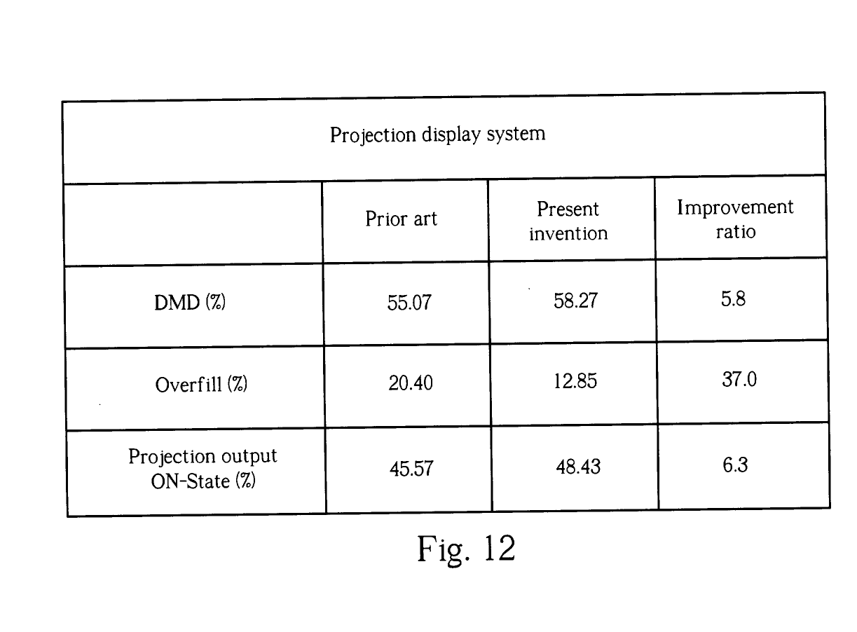

Please refer to FIG. 12, which is a table of experimental results from the projection systems of the prior art and the present invention respectively. The data of a DMD efficiency, an overfill, and an ON-state projection output respectively corresponding to the prior art, the present invention, and the improvement ratio are listed in FIG. 12. For example, the improvement ratio for the DMD efficiency, the overfill, and the ON-state projection output are respectively 5.8%, 37.0% and 6.3%.

The light valve 57 of the embodiment of the projection system 50 is a reflective DMD valve. The light valve 57 can be also a penetrative liquid crystal display or a reflective liquid crystal on silicon (LCOS) display panel.

Following the detailed description of the present invention above, those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for improving asymmetrical projection in a projection system, the projection system comprising a light source, a light valve and an integration rod, the method comprising:
utilizing the light source to emit light beams, the light beams passing through the integration rod and obliquely projecting onto the light valve; and
adjusting a cross section of the integration rod to offset image distortion existed in the projection system.

2. The method of claim 1, further comprising:
adjusting the cross section of the integration rod to distort light beams on a diaphragm along an axis to form an eclipse-shaped projected image whose area is as large as possible, the eclipse-shaped projected image not overlapping with the FLAT-state light beams.

3. The method of claim 1, wherein the cross section of the integration rod is a quadrilateral.

4. The method of claim 1, wherein the projection system further comprises a condenser lens, a stop, and a relay lens, all mounted between the integration rod and the light valve.

5. The method of claim 1, wherein the integration rod is hollow.

6. The method of claim 1, wherein the integration rod is solid.

7. A projection system comprising:
a light source for emitting light beams;
a light valve having a surface onto which the light beams emitted by the light source obliquely projects; and
an integration rod mounted between the light valve and the light source and that adjusting a cross section of the integration rod is capable of offsetting image distortion existing in the projection system.

8. The projection system of claim 7, wherein the light beams are obliquely reflected onto the light valve by a reflection surface.

9. The projection system of claim 7 further comprising a condenser lens, a stop, and a relay lens, all mounted between the integration rod and the light valve.

10. The projection system of claim 7, wherein the light valve is a reflective liquid crystal on silicon (LCOS) panel.

11. The projection system of claim 7, wherein the light valve is a reflective digital micro-mirror device (DMD).

12. The projection system of claim 7, wherein the light valve is a penetrative liquid crystal display (LCD).

13. The projection system of claim 7, wherein the cross section of the integration rod is a quadrilateral.

14. The projection system of claim 7, wherein the integration rod is hollow.

15. The projection system of claim 7, wherein the integration rod is solid.

16. The projection system of claim 7, wherein the cross section of the integration rod is adjustable such that light beams projected on a diaphragm can be distorted along an axis to form an eclipse-shaped projected image whose area is as large as possible by adjusting the cross section of the integration rod, the eclipse-shaped projected image not overlapping with the FLAT state light beams.
